(19) United States
(12) Patent Application Publication
(10) Pub. No.: US 2025/0077088 A1
(43) Pub. Date: Mar. 6, 2025

(54) MEMORY CONTROLLERS AND OPERATING METHODS THEREOF, MEMORY SYSTEMS

(71) Applicant: YANGTZE MEMORY TECHNOLOGIES CO., LTD., Wuhan (CN)

(72) Inventors: Shoujin LIU, Wuhan (CN); Jin ZHENG, Wuhan (CN)

(21) Appl. No.: 18/544,057

(22) Filed: Dec. 18, 2023

(30) Foreign Application Priority Data
Sep. 1, 2023 (CN) 2023111361680

(51) Int. Cl. G06F 3/06; G06F 12/10

(52) U.S. Cl. CPC G06F 3/0614; G06F 3/0656; G06F 3/0679; G06F 12/10

(57) ABSTRACT

Implementations of the present disclosure provide a memory controller and operating method thereof, a memory system. The memory controller includes a buffer and a processor coupled to the buffer; the buffer is configured to buffer a first logical address list; wherein the first logical address list is to indicate continuous N first logical addresses, where N is an integer greater than 1; the N pieces of first data corresponding to the N first logical addresses are of a same data type; the processor is configured to generate a first identification code based on the first logical address list, and buffer the first identification code into the buffer; wherein the first identification code is to indicate the data type of the N pieces of first data.

### CROSS-REFERENCE TO RELATED APPLICATIONS

This application claims priority to Chinese Patent Application No. 2023111361680, which was filed Sep. 1, 2023, is titled “MEMORY CONTROLLERS AND OPERATING METHODS THEREOF, MEMORY SYSTEMS,” and is hereby incorporated herein by reference in its entirety.

### TECHNICAL FIELD

Implementations of the present disclosure relate to the field of semiconductor technology, and in particular to a memory controller and operating method thereof, a memory system.

### BACKGROUND

In recent years, the semiconductor integrated circuit industry has experienced rapid development. With continuous improvement of semiconductor manufacturing process, feature size of semiconductor device continues to be shrink, integration density of memory is getting higher and higher, and memory performance is becoming more and more powerful. Wherein volatile memory requires power to maintain its data, while non-volatile memory may retain stored data when power is not supplied.

Although smaller device size significantly increases memory capacity, which also makes it increasingly challenging to improve storage space utilization of the memory and improve memory reliability.

### SUMMARY

The present disclosure provides a memory controller and operating method thereof and a memory system.

In a first aspect, the present disclosure provides a memory controller, the memory controller includes a buffer and a processor coupled to the buffer; the buffer is configured to buffer a first logical address list; wherein the first logical address list is to indicate continuous N first logical addresses, where N is an integer greater than 1; the N pieces of first data corresponding to the N first logical addresses are of a same data type; the processor is configured to generate a first identification code based on the first logical address list, and buffer the first identification code into the buffer; wherein the first identification code is to indicate the data type of the N pieces of first data.

In some implementations, the first logical address list includes a starting logical address and a length for logical addresses; and wherein the starting logical address is the 1st first logical address or the Nth first logical address in the continuous N first logical addresses; the processor is configured to: determine the starting logical address and the length for logical addresses based on the continuous N first logical addresses.

In some implementations, the buffer is further configured to buffer a second logical address list; wherein the second logical address list is to indicate continuous M second logical addresses, M is an integer greater than 1; the M pieces of second data corresponding to the M second logical addresses are of a same data type; the data type of the second data is different from the data type of the first data; the processor is further configured to generate a second identification code based on the second logical address list, and buffer the second identification code into the buffer; wherein the second identification code is to indicate the data type of the M pieces of second data; the second identification code is different from the first identification code.

In some implementations, the buffer is further configured to buffer P third logical addresses, where P is an integer greater than 0; wherein, the P third logical addresses are discontinuous; the processor is further configured to generate corresponding P third identification codes respectively based on the P third logical addresses, and buffer the third identification codes into the buffer; wherein the third identification code is to indicate the data type of the third data corresponding to the third logical address.

In some implementations, the memory controller is configured to receive a plurality of logical addresses and data corresponding to the plurality of logical addresses; wherein the logical addresses include at least one of the first logical addresses or the third logical addresses; the processor is further configured to: determine whether the plurality of received logical addresses are continuous and whether the data corresponding to the plurality of logical addresses is of the same data type, and generate a result for the determination; when the result for the determination indicates that the plurality of logical addresses are continuous and the data corresponding to the plurality of logical addresses is of a same data type, generate the first identification code based on the result for the determination.

In some implementations, the processor is further configured to: generate a plurality of third identification codes based on the result for the determination when the result for the determination indicates that the plurality of logical addresses are discontinuous.

In some implementations, the processor is further configured to: store the first identification code and the N pieces of first data in the buffer to a memory device based on a sum of capacity for the first identification code and the N pieces of first data reaching a preset capacity; or, store the first identification code and the N pieces of first data in the buffer to the memory device based on at least one of a power-off command from a host or detection of abnormal power-off.

In a second aspect, the present disclosure provides a method for operating a memory controller, the memory controller includes a buffer and a processor coupled to the buffer, the method includes: buffering, by the buffer, a first logical address list; wherein the first logical address list is to indicate continuous N first logical addresses, where N is an integer greater than 1; the N pieces of first data corresponding to the N first logical addresses are of a same data type; generating, by the processor, a first identification code based on the first logical address list, and buffering the first identification code into the buffer; wherein the first identification code is to indicate the data type of the N pieces of first data.

In some implementations, the first logical address list includes a starting logical address and a length for logical addresses; and wherein the starting logical address is the 1st first logical address or the Nth first logical address in the continuous N first logical addresses; the method further includes: determining, by the processor, the starting logical address and the length for logical addresses based on the continuous N first logical addresses.

In some implementations, the method further includes: buffering, by the buffer, a second logical address list; wherein the second logical address list is to indicate continuous M second logical addresses, M is an integer greater than 1; the M pieces of second data corresponding to the M second logical addresses are of a same data type; the data type of the second data is different from the data type of the first data; generating, by the processor, a second identification code based on the second logical address list; and buffering the second identification code into the buffer; wherein the second identification code is to indicate the data type of the M pieces of second data; the second identification code is different from the first identification code.

In some implementations, the method further includes: buffering, by the buffer, P third logical addresses, where P is an integer greater than 0; wherein, the P third logical addresses are discontinuous; generating, by the processor, corresponding P third identification codes respectively based on the P third logical addresses, and buffering the third identification codes into the buffer; wherein the third identification code is to indicate the data type of the third data corresponding to the third logical address.

In some implementations, the method further includes: receiving a plurality of logical addresses and data corresponding to the plurality of logical addresses; wherein the logical addresses include at least one of the first logical addresses or the third logical addresses; determining, by the processor, whether the plurality of received logical addresses are continuous and whether the data corresponding to the plurality of logical addresses is of the same data type, and generate a result for the determination; when the result for the determination indicates that the plurality of logical addresses are continuous and the data corresponding to the plurality of logical addresses is of a same data type, generating, by the processor, the first identification code based on the result for the determination.

In some implementations, the method further includes: generating, by the processor, a plurality of third identification codes based on the result for the determination when the result for the determination indicates that the plurality of logical addresses are discontinuous.

In some implementations, the method further includes: storing, by the processor, the first identification code and the N pieces of first data in the buffer to a memory device based on a sum of capacity for the first identification code and the N pieces of first data reaching a preset capacity; or, storing, by the processor, the first identification code and the N pieces of first data in the buffer to the memory device based on at least one of a power-off command from a host or detection of abnormal power-off.

In a third aspect, the present disclosure provides a memory system, the memory system includes a memory device and a memory controller coupled to the memory device; the memory controller includes a buffer and a processor coupled to the buffer; the buffer is configured to buffer a first logical address list; wherein the first logical address list is to indicate continuous N first logical addresses, where N is an integer greater than 1; the N pieces of first data corresponding to the N first logical addresses are of a same data type; the processor is configured to generate a first identification code based on the first logical address list, and buffer the first identification code into the buffer; wherein the first identification code is to indicate the data type of the N pieces of first data; the processor is further configured to store the first identification code and the N pieces of first data in the buffer to the memory device.

In some implementations, the first logical address list includes a starting logical address and a length for logical addresses; and wherein the starting logical address is the 1st first logical address or the Nth first logical address in the continuous N first logical addresses; the processor is configured to: determine the starting logical address and the length for logical addresses based on the continuous N first logical addresses.

In some implementations, the buffer is further configured to buffer P third logical addresses, where P is an integer greater than 0; wherein, the P third logical addresses are discontinuous; the processor is further configured to generate corresponding P third identification codes respectively based on the P third logical addresses, and buffer the third identification codes into the corresponding buffer; wherein the third identification code is to indicate the data type of the third data corresponding to the third logical address.

In some implementations, the memory controller is configured to receive a plurality of logical addresses and data corresponding to the plurality of logical addresses; wherein the logical addresses include at least one of the first logical addresses or the third logical addresses; the processor is further configured to: determine whether the plurality of received logical addresses are continuous and whether the data corresponding to the plurality of logical addresses is of the same data type, and generate a result for the determination; when the result for the determination indicates that the plurality of logical addresses are continuous and the data corresponding to the plurality of logical addresses is of a same data type, generate the first identification code based on the result for the determination.

In some implementations, the processor is further configured to: generate a plurality of third identification codes based on the result for the determination when the result for the determination indicates that the plurality of logical addresses are discontinuous.

In some implementations, the processor is further configured to: store the first identification code and the N pieces of first data in the buffer to a memory device based on a sum of capacity for the first identification code and the N pieces of first data reaching a preset capacity; or, store the first identification code and the N pieces of first data in the buffer to the memory device based on at least one of a power-off command from a host or detection of abnormal power-off.

In some implementations, the N first logical addresses are continuous, and the N pieces of first data corresponding to the N first logical addresses are of the same data type, the processor is configured to generate a first identification code based on the first logical address list, and buffer the first identification code into the buffer.

### BRIEF DESCRIPTION OF THE DRAWINGS

FIG. 1 is a schematic diagram of a system having a memory according to some implementations of the present disclosure;

FIG. 2a is a schematic diagram of a memory card according to some implementations of the present disclosure;

FIG. 2b is a schematic diagram of a Solid State Drive (SSD) according to some implementations of the present disclosure;

FIG. 3 is a schematic diagram of a memory system according to some implementations of the present disclosure;

FIG. 4 is a schematic diagram of an identification code and a logical address stored in a buffer and a memory device according to some implementations of the present disclosure;

FIG. 5 is a schematic diagram of a first identification code and a first logical address list stored in a buffer and a memory device according to some implementations of the present disclosure;

FIG. 6 is a schematic diagram of a second identification code and a second logical address list stored in a buffer and a memory device according to some implementations of the present disclosure;

FIG. 7 is a schematic diagram of a third identification code and a third group of logical addresses stored in a buffer and a memory device according to some implementations of the present disclosure;

FIG. 8 is a flowchart of a method of operating a memory controller shown according to some implementations of the present disclosure.

### DETAILED DESCRIPTION

To facilitate understanding of the present disclosure, exemplary implementations of the present disclosure will be described in more detail below with reference to the relevant accompanying drawings. Although exemplary implementations of the present disclosure are shown in the accompanying drawings, it should be understood that the present disclosure may be implemented in various forms and should not be limited to the implementations set forth herein. Rather, these implementations are provided so that the present disclosure can be more thoroughly understood and the scope of the present disclosure can be fully conveyed to those skilled in the art.

In the following description, numerous details are given in order to provide a more thorough understanding of the present disclosure. However, it will be apparent to one skilled in the art that the present disclosure may be practiced without one or more of these details. In some implementations, in order to avoid confusion with the present disclosure, some technical features known in the art are not described; that is, not all features of the actual example may be described here, and well-known functions and structures may be not described in detail.

Generally, a term may be understood, at least in part, from context of use. For example, depending at least in part on context, the term “one or more” as used herein may be used in the singular to describe any feature, structure or characteristic, or may be used in the plural to describe a combination of features, structures or characteristics. Similarly, terms such as “a” or “the” may equally be understood to convey a singular usage or to convey a plural usage, depending at least in part on the context. Additionally, the term “based on” may be understood as not necessarily intended to convey an exclusive set of factors, and may alternatively allow for the presence of additional factors that are not necessarily explicitly described, which again depends at least in part on context.

Unless otherwise defined, the terminology used herein is for the purpose of describing a particular example only and is not to be considered as limitation of the present disclosure. As used herein, the singular forms “a”, “an” and “said/the” are intended to include the plural forms as well, unless the context clearly dictates otherwise. It should also be understood that the terms “consists of” and/or “comprising”, when used in this description, identify the presence of stated features, integers, steps, operations, elements and/or parts, but do not exclude the presence or addition of one or more other features, integers, steps, operations, elements, parts and/or groups. As used herein, the term “and/or” includes any and all combinations of the associated listed items.

In order to thoroughly understand the present disclosure, detailed steps and detailed structures will be provided in the following description, so as to explain the technical solution of the present disclosure. Preferred implementations of the present disclosure are described in detail as follows, however, the present disclosure may have other implementations other than these detailed descriptions.

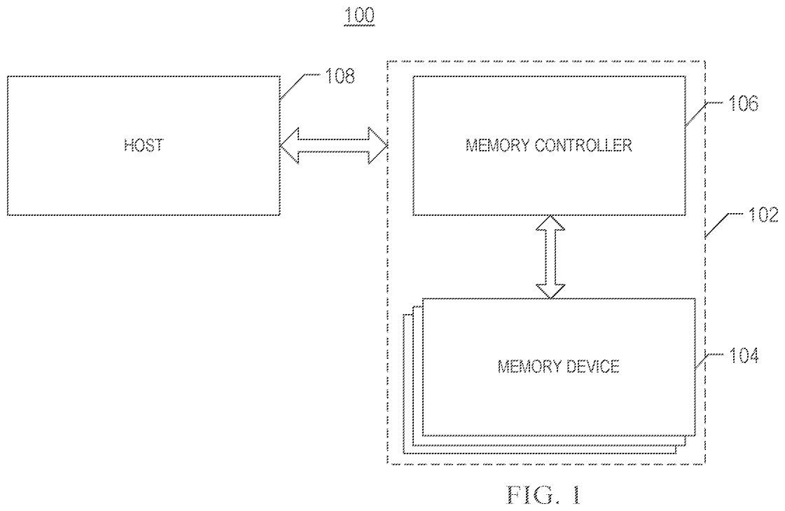

FIG. 1 illustrates a schematic diagram of a system 100 having a memory according to some aspects of the present disclosure. The system 100 may be a mobile phone, a desktop computer, a laptop computer, a tablet, a vehicle computer, a gaming console, a printer, a positioning device, a wearable electronic device, a smart sensor, a Virtual Reality (VR) device, an Augmented Reality (AR) device, or any other suitable electronic devices having storage therein.

As shown in in FIG. 1, system 100 may include a host 108 and a memory system 102, and the memory system 102 has one or more memory devices 104 and a memory controller 106. The host 108 may be a processor of an electronic device (e.g., a Central Processing Unit (CPU)) or a System on Chip (SoC) (e.g., an Application Processor (AP)). Host 108 may be configured to send data to or receive data from memory device 104.

According to some implementations, memory controller 106 is coupled to memory device 104 and host 108, and configured to control memory device 104. Memory controller 106 may manage data stored in memory device 104 and communicate with host 108. In some implementations, the memory controller 106 is designed to operate in low duty cycle environments, e.g., Secure Digital Memory Card (SD Card), Compact Flash Card (CF Card), Universal Serial Bus (USB) flash drive, or other media for use in electronic devices such as personal computer, digital camera, mobile phone, etc. In some implementations, the memory controller 106 is designed to operate in high duty cycle environments Solid State Drive (SSD) or Embedded Multi Media Card (eMMC), where SSD or eMMC is used as data storage for mobile devices such as smartphone, tablet computer, laptop computer, and enterprise storage array.

Memory controller 106 may be configured to control operations of memory device 104, e.g., read, erase and write (also referred to as program) operations. Memory controller 106 may also be configured to manage various functions related to data stored or to be stored in memory device 104, including but not limited to bad block management, garbage collection, logical-to-physical address translation, wear leveling, etc. In some implementations, memory controller 106 is further configured to process Error Correction Code (ECC) related to data read from or written to memory device 104. Memory controller 106 may also perform any other suitable functions, e.g., formatting memory device 104. Memory controller 106 may communicate with a host (e.g., host 108) according to a particular communication protocol. For example, memory controller 106 may communicate with host 108 through at least one of various interface protocols, such as USB protocol, MMC protocol, Peripheral Component Interconnect (PCI) protocol, Peripheral Component Interconnect Express (PCI-E) protocol, Advanced Technology Attachment (ATA) protocol, Serial ATA protocol, Parallel ATA protocol, Small Computer System Interface (SCSI) protocol, Enhanced System Device Interface (ESDI) protocol, Integrated Drive Electronics (IDE) protocol, Firewire protocol, etc.

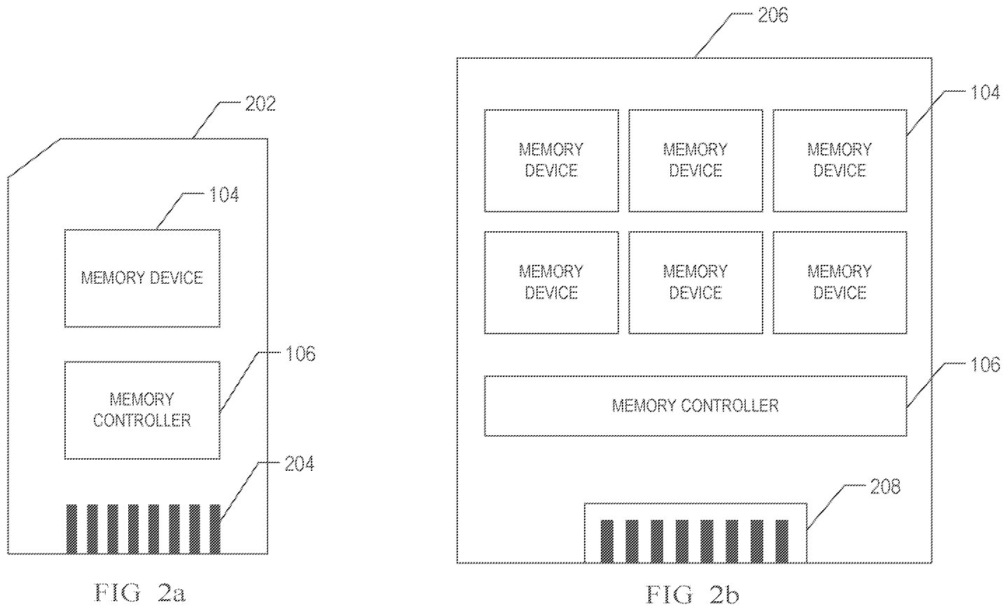

Memory controller 106 and one or more memory devices 104 may be integrated into various types of storage devices, e.g., included in the same package (e.g., Universal Flash Storage package or eMMC package). That is, memory system 102 may be implemented and packaged into different types of end electronic products. In one example as shown in FIG. 2a, memory controller 106 and a single memory device 104 may be integrated into a memory card 202. A memory card 202 may include a PC card (Personal Computer Memory Card International Association, PCMCIA), a CF card, a Smart Media (SM) card, a memory stick, a Multi Media Card (MMC), Reduced-Size MMC (RS-MMC), Multi Media Card Micro (MMCmicro), SD card (SD, miniSD, microSD, SDHC), Universal Flash Storage (UFS), etc. Memory card 202 may further include a memory card connector 24 coupling memory card 202 with a host (e.g., host 108 in FIG. 1). In another example as shown in FIG. 2b, memory controller 106 and a plurality of memory devices 104 may be integrated into a SSD 206. SSD 27 may further include an SSD connector 208 coupling SSD 206 with a host (e.g., host 108 in FIG. 1). In some implementations, at least one of the storage capacity or operating speed of SSD 206 is greater than at least one of the storage capacity or operating speed of memory card 202.

In implementations of the present disclosure, each of the memory die may include one or more memory cell arrays. One type of memory cell, e.g., a single-level cell (SLC), may store one bit per cell. Other types of memory cells, e.g., Multi-Level Cell (MLC), Triple-Level Cell (TLC), Quad-Level Cell (QLC) and Penta-Level Cell, PLC) may store several bits per cell. In some implementations, each of the memory devices may include one or more memory cell arrays, e.g., a SLC array, a MLC array, a TLC array, a QLC array, or any combination of such memory cell arrays.

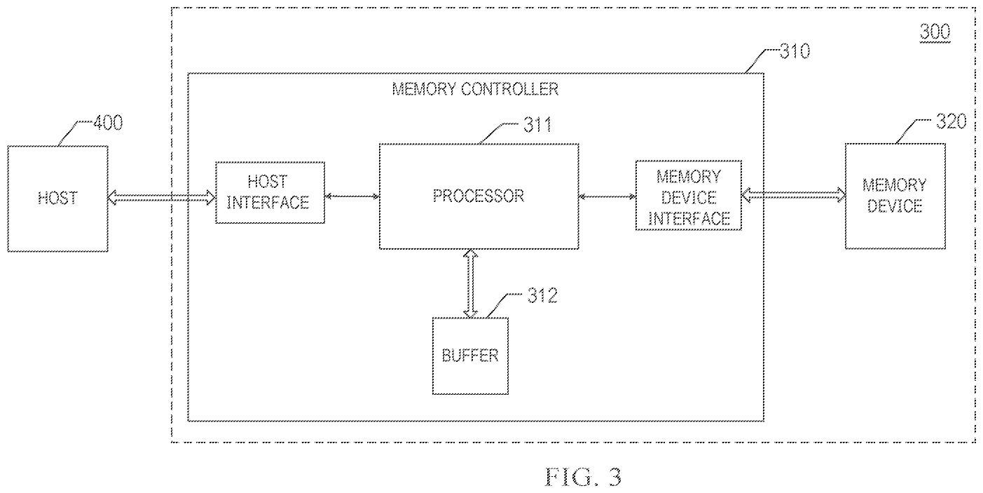

FIG. 3 is a schematic diagram of a memory system 300 provided by an example of the present disclosure, wherein the memory system 300 includes a memory controller 310 and at least one memory device 320 coupled to the memory controller 310, the memory controller 310 includes a processor 311 and buffer 312. The memory system 300 includes but is not limited to a solid state drive, e.g., Enterprise SSD (eSSD), etc. The memory device 320 may be a non-volatile memory device, e.g., a NAND type memory, a NOR type memory, etc., the memory controller 310 may include at least one of one or more integrated circuits or discrete components, buffers or hardware combinations thereof, and the memory controller 310 may be configured to receive data and commands from the host 400 and perform operations such as read, erase and write on the memory device 320. The processor 311 in the memory controller 310 may be a microcontroller, a dedicated logic circuit system (e.g., Field Programmable Gate Array (FPGA), Application Specific Integrated Circuit (ASIC)), etc. The buffer 312 may be a Static Random Access Memory (SRAM), a Dynamic Random Access Memory (DRAM), etc. The following description takes the buffer 312 being SRAM as an example.

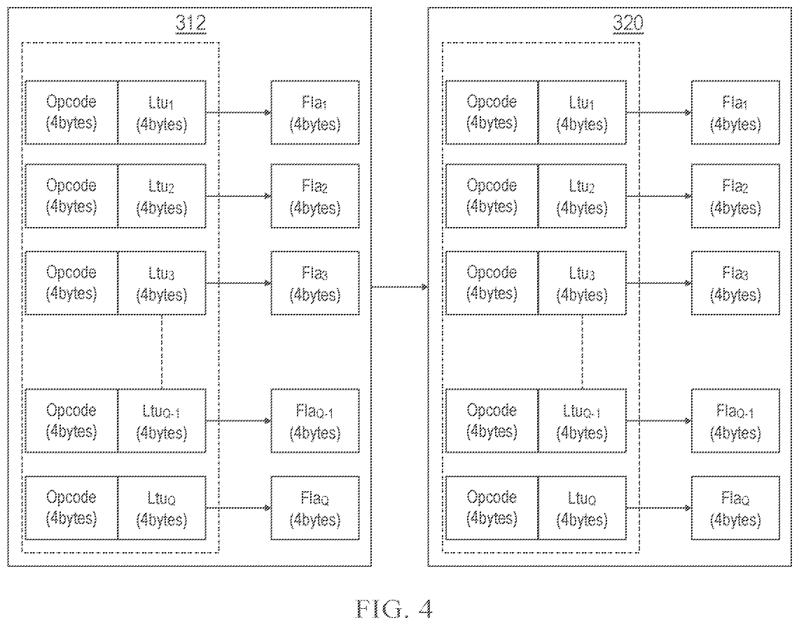

FIG. 4 is a schematic diagram of identification codes and logical addresses in the buffer 312 and the memory device 320 provided by an example of the present disclosure. The buffer 312 may be used to buffer multiple pieces of data (not shown in FIG. 4), as well as mapping information from logical address to physical address (Logical-to-Physical Mapping Table, L2P) corresponding to the plurality of pieces of data, where each piece of data corresponds to a logical address and a physical address. The logical addresses of the multiple pieces of data here may be continuous, i.e., sequential data; and the logical addresses of the multiple pieces of data may also be discontinuous, i.e., random data. For example, each of the Q logical addresses Ltu₁ to Ltu_{Q} in the buffer 312 one-to-one corresponds to each of the Q physical addresses Fla₁ to Fla_{Q} respectively, and Q is an integer greater than 0. The buffer 312 may also store Q identification codes Opcode, and each identification code Opcode is to indicate the data type of a piece of data corresponding to a logical address to facilitate tracking of the source of each data, the data type here includes but is not limited to Trim data, Host data, Garbage Collection (GC) data or Wear Leveling (WL) data. It may be understood that data types indicated by any two identification codes Opcode may be the same or different, i.e., data types of any two pieces of data may be the same or different. In some implementations, each identification code occupies a storage space of 4 bytes, each logical address occupies a storage space of 4 bytes, and each physical address also occupies a storage space of 4 bytes.

Since the buffer 312 may be a volatile memory and has a small storage capacity, the mapping information from the logical address to physical address in the buffer 312 and a plurality of identification codes corresponding to several pieces of data may be transferred to the memory device 320 if certain conditions are met. For example, when a sum of capacity for storing the identification code, the logical address, the physical address and the data (or any one or a combination of the four) in the buffer 312 reaches the preset capacity, the processor 311 may transfer the identification code, the logical address, the physical address and the data in the buffer 312 to the memory device 320; in addition, the processor 311 may also transfer the identification code, logical address, physical address and data in the buffer 312 to the memory device 320 based on at least one of a power-off command from a host 400 or detection of abnormal power-off.

It is to be understood that each piece of data requires an identification code Opcode to identify its data type, meanwhile, each piece of data also requires a corresponding logical address to establish a mapping relationship between logical address and physical address. For example, Q pieces of data requires storage space of 4Q bytes to store Q identification codes, and also requires storage space of 4Q bytes to store Q logical addresses. This results in a large storage space occupied by the identification code and logical address in the buffer 312 and also a large storage space occupied in the memory device 320, thus the storage space utilization of the buffer 312 and the memory device 320 is low. In addition, since the identification codes and logical addresses occupy a large storage space, when the processor 311 receives a power-off command from the host 400, the identification codes and logical addresses are transferred from the buffer 312 to the memory device 320 at a low speed, thus affecting the working efficiency of the memory system 300; and in the case of an abnormal power-off, the low transfer speed of the identification codes and logical addresses from the buffer 312 to the memory device 320 may cause data error and data loss, thereby affecting the reliability of the memory system 300.

Based on this, in order to solve one or more of the technical problems described above, an example of the present disclosure provides a memory.

As shown in FIG. 3, the present disclosure provides a memory controller 310, the memory controller 310 includes a buffer 312 and a processor 311 coupled to the buffer 312; the buffer 312 is configured to buffer a first logical address list; wherein the first logical address list is to indicate continuous N first logical addresses, where Nis an integer greater than 1; the N pieces of first data corresponding to the N first logical addresses are of a same data type; the processor 311 is configured to generate a first identification code based on the first logical address list, and buffer the first identification code into the buffer 312; wherein the first identification code is to indicate the data type of the N pieces of first data.

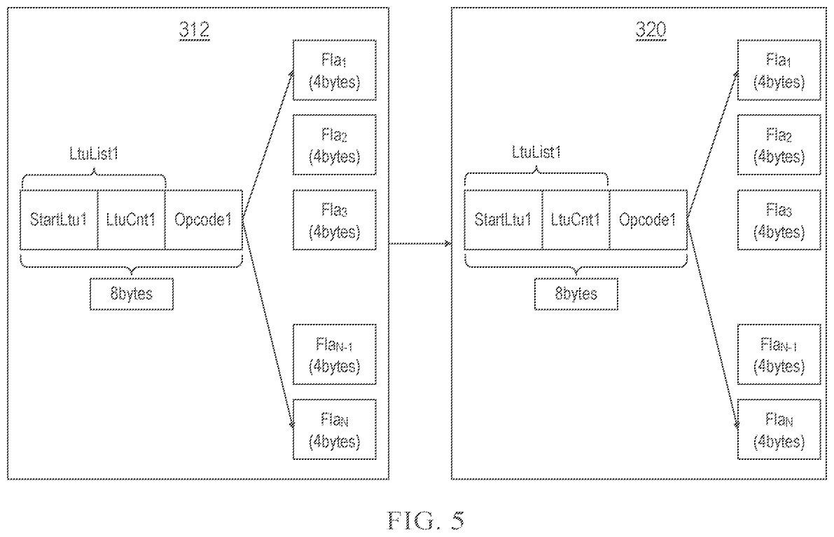

In an example of the present disclosure, referring to FIG. 5, the first logical address list Ltulist1 indicates continuous N first logical addresses, the processor 311 may generate a first identification code Opcode1 based on N pieces of first data which may correspond to continuous logical addresses and be of the same data type and the first logical address list Ltulist1, and buffer the first identification code Opcode1 into the buffer 312, wherein it may be understood that the N pieces of first data here are sequential data. For example, the data type represented by the first identification code Opcode1 includes but is not limited to one of trim data, host data, garbage collection data or wear leveling data.

In this way, for N pieces of first data, only one first identification code Opcode1 is to label its data type, which, compared with the example shown in FIG. 4 (for each piece of data, one identification code is to label its data type), may greatly reduce the storage space occupied by the identification code, and result in a high storage space utilization of the buffer 312 and the memory device 320; in addition, when the processor 311 receives a power-off command from the host 400 (i.e., the memory system is powered off normally), the first identification code Opcode1 is transferred from the buffer 312 to the memory device 320 at a high speed and the operation time required for normal power-off is short, thus the working efficiency of the memory system 300 is improved; and in the case of an abnormal power-off, the first identification code Opcode1 is transferred from the buffer 312 to the memory device 320 at a high speed and the probability of data error and data loss is low, thus the reliability of the memory system 300 is improved.

It should be noted that the first logical address list Ltulist1 stored in the buffer 312 may also be generated by the processor 311, and reference may be made to subsequent implementations for some methods.

In addition, for random data (i.e., several pieces of data which correspond to discontinuous logical addresses), or when any two pieces of data corresponding to adjacent logical addresses in several pieces of sequential data are of different data types (e.g., although Ltu₁ and Ltu₂ are continuous, the data types of the two corresponding pieces of data are different), the processor 311 may still adopt the method of the example shown in FIG. 4, i.e., generating a corresponding identification code for each piece of data, so as to achieve the compatibility of sequential data and random data.

In some implementations, as shown in FIG. 5, the first logical address list Ltulist1 includes a starting logical address StartLtu1 and a length for logical addresses LtuCnt1; and wherein the starting logical address is the 1st first logical address or the Nth first logical address in the continuous N first logical addresses; the processor is configured to: determine the starting logical address StartLtu1 and the length for logical addresses LtuCnt1 based on the continuous N first logical addresses.

In some implementations, the processor may further determine the starting logical address StartLtu1 and the length for logical addresses LtuCnt1 based on the continuous N first logical addresses. For example, the continuous N first logical addresses are Ltu₁, Ltu₂ . . . . Ltu_{N-1}, Ltu_{N} respectively, and the processor may determine Ltu₁ or Ltu_{N} as the starting logical address StartLtu (i.e., the 1st first logical address or the last first logical address), and determine N as the length for logical addresses LtuCnt1. In this way, the starting logical address StartLtu1 and the length for logical addresses LtuCnt1 constitute the first logical address list Ltulist1, and the starting logical address StartLtu1 and the length for logical addresses LtuCnt1 may be used to represent continuous N first logical addresses. It may be understood that compared with each piece of data that requires a corresponding logical address to establish an L2P mapping relationship in FIG. 4, for the N pieces of first data here, only a starting logical address StartLtu1 and a length for logical addresses LtuCnt1 are required to establish the L2P mapping relationship, so that the storage space occupied by the logical addresses in the buffer is further scaled. While improving the storage space utilization of the buffer and memory device, the processor may also quickly store the identification code and logical addresses (L2P mapping information) in the buffer into the non-volatile memory device to reduce the risk of data errors and loss, thereby improving the reliability of the memory system.

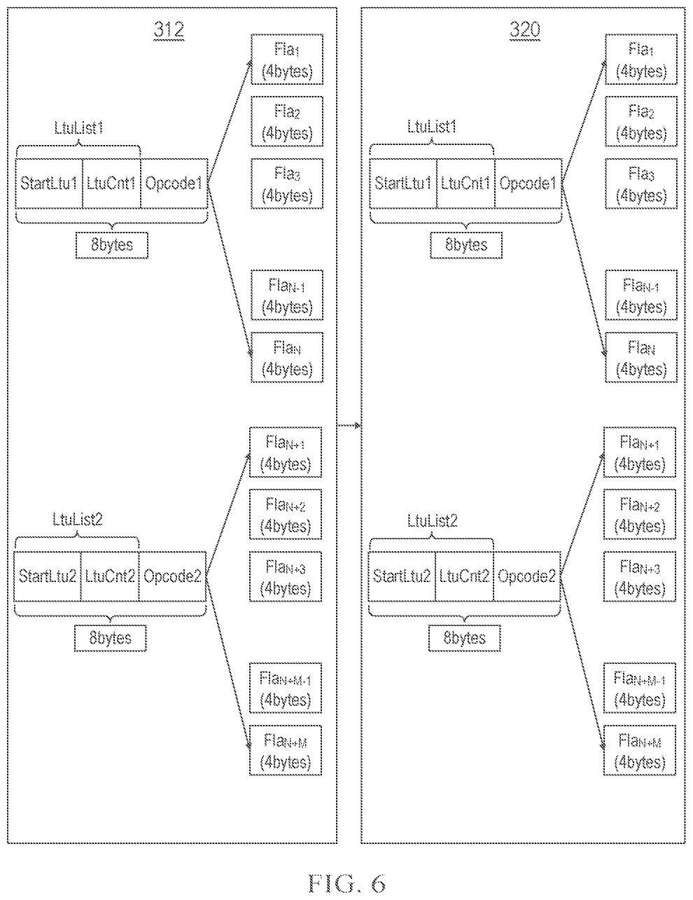

In some implementations, as shown in FIG. 6, the buffer 312 is further configured to buffer a second logical address list Ltulist2; wherein the second logical address list Ltulist2 is to indicate continuous M second logical addresses, M is an integer greater than 1; the M pieces of second data corresponding to the M second logical addresses are of a same data type; the data type of the second data is different from the data type of the first data; the processor is further configured to generate a second identification code Opcode2 based on the second logical address list Ltulist2, and buffer the second identification code Opcode2 into the buffer; wherein the second identification code Opcode2 is to indicate the data type of the M pieces of second data; the second identification code Opcode2 is different from the first identification code Opcode1.

In some implementations, the processor may also generate a plurality of different identification codes based on sequential data of different data types, i.e., sequential data of the same data type generates a corresponding identification code. For example, the processor may generate a first logical address list Ltulist1 based on the N pieces of first data corresponding to continuous logical addresses, and generate a first identification code Opcode1 based on the first logical address list Ltulist1; and the processor may also generate a second logical address list Ltulist2 based on the M pieces of second data corresponding to continuous logical addresses, and generate a second identification code Opcode2 based on the second logical address list Ltulist2, where the first identification code Opcode1 and the second identification code Opcode2 indicate different data types.

It may be understood that in addition to the first identification code Opcode1 and the second identification code Opcode2, the buffer 312 may also store other identification codes, wherein one identification code may be used to represent the data type of several pieces of data which may be of the same data type and correspond to continuous logical addresses (an identification code may also represent the data type of a piece of random data), the number of identification codes is not limited here. That is to say, the buffer 312 may store a plurality of groups of logical addresses, and each group of logical addresses is configured with a corresponding identification code.

For example, k pieces of data correspond to k continuous logical addresses Ltu₁, Ltu₂ . . . . Ltuₖ₋₁, Ltuₖ, respectively, k>M+N and k is an integer, wherein the data types of the 1st to the Nth piece of data are the same and the logical addresses Ltu1 to Ltu_{N} are continuous (i.e., the N pieces of first data described above), the data types of the (N+1)-th to the (N+M)-th piece of data are the same and the logical addresses LtuN to LtuN+M are continuous (i.e., the M pieces of first data described above), the data types of the (N+M+1)-th to the k-th piece of data are the same and the logical addresses Ltu_{N+M} to Ltuₖ are continuous (referred to as the fourth data for case of understanding), here the data types of the first data, the second data and the fourth data are different. In this way, the processor may generate corresponding first identification code, second identification code and fourth identification code respectively, and buffer the first identification code, second identification code and fourth identification code into the buffer 312. It may be noted that the data types of the first data and the fourth data here may also be the same, but the processor may still generate the first identification code and the fourth identification code (the storage location of the identification code in the buffer or memory device may be adjacent to the corresponding group of logical addresses, so that it may be easy to be distinguished in the case that the data types are the same). In this way, several pieces of data and corresponding L2P information and identification codes may be flexibly stored, thereby the storage space for identification codes and logical addresses may be scaled as much as possible to improve the storage space utilization of the buffer and memory device and the stability of the memory system may be improved.

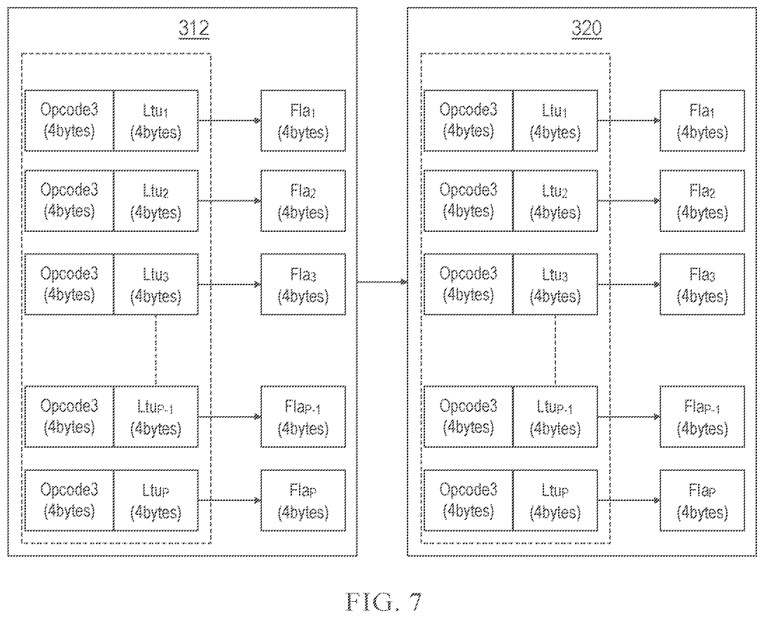

In some implementations, as shown in FIG. 7, the buffer 312 is further configured to buffer P third logical addresses, where P is an integer greater than 0; wherein, the P third logical addresses are discontinuous; the processor is further configured to generate corresponding P third identification codes Opcode3 respectively based on the P third logical addresses, and buffer the third identification codes Opcode3 into the buffer 312; wherein the third identification codes Opcode3 is to indicate the data type of the third data corresponding to the third logical address.

In In some implementations, the processor may also generate corresponding P third identification codes Opcode3 based on P pieces of third data corresponding to discontinuous logical addresses and corresponding P discontinuous third logical addresses, and buffer the third identification code Opcode3 into the buffer 312. It may be understood that each third identification code Opcode3 here is to indicate the data type of a piece of third data, thus the data types indicated by any two third identification codes Opcode3 may be the same or different.

It should be noted that the buffer 312 may include one or more of the first identification code, the second identification code and the third identification code. That is, for sequential data, the processor may determine whether the data types are the same, and then choose whether to scale the identification code and group of logical addresses, thereby the storage space utilization of the buffer and memory device may be improved; and for random data, the processor may adopt the method illustrated in the example shown in FIG. 4, i.e., for each piece of data, a corresponding identification code is generated, so as to achieve compatibility of sequential data and random data.

In some implementations, the memory controller 310 is configured to receive a plurality of logical addresses and data corresponding to the plurality of logical addresses; wherein the logical addresses include at least one of the first logical addresses or the third logical addresses; the processor 311 is further configured to: determine whether the plurality of received logical addresses are continuous and whether the data corresponding to the plurality of logical addresses is of the same data type, and generate a result for the determination; when the result for the determination indicates that the plurality of logical addresses are continuous and the data corresponding to the plurality of logical addresses is of a same data type, generate the first identification code based on the result for the determination.

In some implementations, the processor 311 is further configured to: generate a plurality of third identification codes based on the result for the determination when the result for the determination indicates that the plurality of logical addresses are discontinuous.

In In some implementations, the processor 311 may detect and determine the continuity of a plurality of logical addresses corresponding to several pieces of data, as well as the data types of the plurality of pieces of data, and generate a result for the determination, and then based on the result for the determination, generate a first identification code (sequential data and the same data type) or a plurality of third identification codes (random data, or data types of any two pieces of data corresponding to adjacent logical addresses in several pieces of sequential data are different). Here, the processor 311 may include an arbiter circuit configured to perform the above operation of determining to generate a result for the determination. It should be noted that there are no limitations on the order of determining whether the logical addresses of several pieces of data are continuous and whether the data types of several pieces of data are the same, the order of determining may be determined according to actual design requirements.

For example, the memory controller 310 receives k pieces of data and corresponding k logical addresses, where the 1st to (i−1)-th logical addresses are discontinuous, the i-th to the j-th logical addresses are continuous, and the (j+1)-th to the k-th logical addresses are not continuous, i, j, and k are all positive integers, and i>2, i<j, j+1<k; the data types of the i-th piece of data to the t-th data are the same, it and t+2<j, and the data type of the (t+1)-th piece of data is different from the data types of the i-th piece of data to the t-th data, the data types of the (t+2)-th piece of data to the j-th piece of data are the same, and the data types of the (t+2)-th piece of data to the j-th piece of data are different from the data type of the (t+1)-th piece of data. In this way, the processor 311 may generate corresponding (i−1)-th identification codes based on the 1st to the (i−1)-th piece of data, generate corresponding 1 identification code based on the i-th to the t-th piece of data, generate corresponding 1 identification code based on the (t+1)-th piece of data, generate corresponding 1 identification code based on the (t+2)-th to the j-th piece of data, and generate corresponding (k-j) identification codes based on the (j+1)-th to the k-th piece of data.

In some implementations, the processor 311 is further configured to: store the first identification code and the N pieces of first data in the buffer 312 to a memory device 320 based on a sum of capacity for the first identification code and the N pieces of first data reaching a preset capacity; or, store the first identification code and the N pieces of first data in the buffer 312 to the memory device 320 based on at least one of a power-off command from the host 400 or detection of abnormal power-off.

In some implementations, since the buffer 312 is generally a volatile memory and has a small storage capacity, the mapping information from the logical address to physical address in the buffer 312 and a plurality of identification codes corresponding to several pieces of data may be transferred to the memory device 320 if certain conditions are met. For example, when a sum of capacity for storing the identification code, the logical address, the physical address and the data (or any one or a combination of the four) in the buffer 312 reaches the preset capacity, the processor 311 may transfer the identification code, the logical address, the physical address and the data in the buffer 312 to the memory device 320. The preset capacity here is less than or equal to the total capacity of the buffer 312, the preset capacity here may be determined based on the total capacity of the buffer 312 and the read and write performance requirements of the memory system 300.

In addition, the processor 311 may also transfer the identification code, logical address, physical address and data in the buffer 312 to the memory device 320 based on at least one of a power-off command from the host 400 or detection of abnormal power-off. In this way, the storage space occupied by the identification code and the logical address may be greatly reduced, so that the storage space utilization of the buffer 312 and the memory device 320 is high; in addition, since the storage space occupied by the identification code and the logical address is reduced, when the processor 311 receives a power-off command from the host 400 (i.e., the memory system is powered off normally), the identification code and logical address are transferred from the buffer 312 to the memory device 320 at a high speed and the operation time required for normal power-off is short, thus the working efficiency of the memory system 300 is improved; and in the case of an abnormal power-off, the identification code is transferred from the buffer 312 to the memory device 320 at a high speed and the probability of data error and data loss is low, thus the reliability of the memory system 300 is improved.

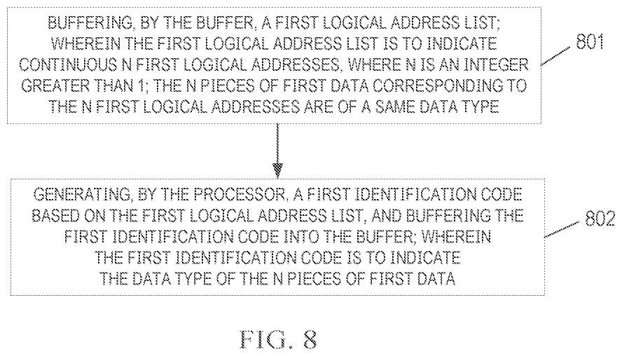

The present disclosure provides a method for operating a memory controller, the memory controller includes a buffer and a processor coupled to the buffer, the method may be described as follows in conjunction with the flow chart of the method for operating a memory controller shown in FIG. 8. The method includes the following operations.

Operation 801: buffering, by the buffer, a first logical address list; wherein the first logical address list is to indicate continuous N first logical addresses, where N is an integer greater than 1; the N pieces of first data corresponding to the N first logical addresses are of a same data type.

Operation 802: generating, by the processor, a first identification code based on the first logical address list, and buffering the first identification code into the buffer; wherein the first identification code is to indicate the data type of the N pieces of first data.

In some implementations, the first logical address list includes a starting logical address and a length for logical addresses; and wherein the starting logical address is the 1st first logical address or the Nth first logical address in the continuous N first logical addresses; the processor determines the starting logical address and the length for logical addresses based on the continuous N first logical addresses.

In some implementations, the buffer can buffer a second logical address list; wherein the second logical address list is to indicate continuous M second logical addresses, M is an integer greater than 1; the M pieces of second data corresponding to the M second logical addresses are of a same data type; the data type of the second data is different from the data type of the first data.

In some implementations, the processor generates a second identification code based on the second logical address list; and buffering the second identification code into the buffer; wherein the second identification code is to indicate the data type of the M pieces of second data; the second identification code is different from the first identification code.

In some implementations, the buffer buffers P third logical addresses, where P is an integer greater than 0; wherein, the P third logical addresses are discontinuous; the processor generates corresponding P third identification codes respectively based on the P third logical addresses, and buffering the third identification codes into the buffer; wherein the third identification code is to indicate the data type of the third data corresponding to the third logical address.

In some implementations, the controller receives a plurality of logical addresses and data corresponding to the plurality of logical addresses; wherein the logical addresses include at least one of the first logical addresses or the third logical addresses; the processor determines whether the plurality of received logical addresses are continuous and whether the data corresponding to the plurality of logical addresses is of the same data type, and generate a result for the determination.

In some implementations, when the result for the determination indicates that the plurality of logical addresses are continuous and the data corresponding to the plurality of logical addresses is of a same data type, generating, by the processor, the first identification code based on the result for the determination.

In some implementations, the processor generates a plurality of third identification codes based on the result for the determination when the result for the determination indicates that the plurality of logical addresses are discontinuous.

In some implementations, the processor stores the first identification code and the N pieces of first data in the buffer to a memory device based on a sum of capacity for the first identification code and the N pieces of first data reaching a preset capacity; or, the processor stores the first identification code and the N pieces of first data in the buffer to the memory device based on at least one of a power-off command from the host or detection of abnormal power-off.

In some implementations, the present disclosure also provides a computer readable storage media having executable instructions stored thereon, which, when executed, implement the method of any one of the implementations described above. For example, executable instructions may be stored in the memory device 320 and may be executed by the processor 311, in one example, the executable instructions may be instructions related to Flash Translation Layer (FTL). Executable instructions may also be referred to as firmware.

As shown in FIG. 3, the present disclosure provides a memory system 300, the memory system 300 includes a memory device 320 and a memory controller 310 coupled to the memory device 320; the memory controller 310 includes a buffer 312 and a processor 311 coupled to the buffer 312.

In some implementations, the buffer 312 is configured to buffer a first logical address list; wherein the first logical address list is to indicate continuous N first logical addresses, where N is an integer greater than 1; the N pieces of first data corresponding to the N first logical addresses are of a same data type.

In some implementations, the processor 311 is configured to generate a first identification code based on the first logical address list, and buffer the first identification code into the buffer 312; wherein the first identification code is to indicate the data type of the N pieces of first data.

In some implementations, the processor 311 is further configured to store the first identification code and the N pieces of first data in the buffer 312 to the memory device 320.

In some implementations, the memory controller 310 may be configured to receive data and commands from the host 400 and perform operations on the memory device 320, e.g., read, erase, and write operations. The processor 311 in the memory controller 310 may be a microcontroller, a dedicated logic circuit system (e.g., field programmable gate array, application specific integrated circuit), etc. The buffer 312 may be a static random access memory, a dynamic random access memory, etc. The buffer 312 may be used to buffer several pieces of data, as well as mapping information from logical address to physical address corresponding to the plurality of pieces of data, where each piece of data corresponds to a logical address and a physical address. The logical addresses corresponding to several pieces of data here may be continuous, i.e., sequential data, and the logical addresses of several pieces of data may also be discontinuous, i.e., random data.

The processor 311 may generate a first identification code based on N pieces of first data with continuous logical addresses and a same data type and the first logical address list, and buffer the first identification code into the buffer 312, it may be understood that the N pieces of first data here are sequential data. For example, the data type represented by the first identification code includes but is not limited to one of trim data, host data, garbage collection data or wear leveling data.

Since the buffer 312 is generally a volatile memory and has a small storage capacity, the mapping information from the logical address to physical address in the buffer 312 and a plurality of identification codes corresponding to several pieces of data may be transferred to the memory device 320 if certain conditions are met. For example, when a sum of capacity for storing the first identification code in the buffer 312, the first logical address, the physical address and the first data (or any one or a combination of the four) reaches the preset capacity, the processor 311 may transfer the first identification code, the first logical address, the physical address and the first data in the buffer 312 to the memory device 320. The preset capacity here may be determined based on the total capacity of the buffer 312 and the read and write performance requirements of the memory system 300. In addition, the processor 311 may also transfer the first identification code, the first logical address, physical address and the first data in the buffer 312 to the memory device 320 based on at least one of a power-off command from the host 400 or detection of abnormal power-off.

In this way, for N pieces of first data, only one first identification code is required to label its data type, which, compared with the example shown in FIG. 4 (for each piece of data, one identification code is required to label its data type), may greatly reduce the storage space occupied by the identification code and result in a high storage space utilization of the buffer 312 and the memory device 320; in addition, when the processor 311 receives a power-off command from the host 400, the first identification code is transferred from the buffer 312 to the memory device 320 at a high speed, thus the working efficiency of the memory system 300 is improved; and in the case of an abnormal power-off, the first identification code is transferred from the buffer 312 to the memory device 320 at a high speed and the probability of data error and data loss is low, thus the reliability of the memory system 300 is improved.

It should be noted that the first logical address list stored in the buffer 312 may also be generated by the processor 311, and reference may be made to implementations described above for some methods, which will not be repeated here.

In some implementations, the first logical address list includes a starting logical address and a length for logical addresses; and wherein the starting logical address is the 1st first logical address or the Nth first logical address in the continuous N first logical addresses.

In some implementations, the processor is configured to determine the starting logical address and the length for logical addresses based on the continuous N first logical addresses.

In some implementations, the buffer is further configured to buffer P third logical addresses, where P is an integer greater than 0; wherein, the P third logical addresses are discontinuous.

In some implementations, the processor is further configured to generate corresponding P third identification codes respectively based on the P third logical addresses, and buffer the third identification codes into the corresponding buffer; wherein the third identification code is to indicate the data type of the third data corresponding to the third logical address.

In some implementations, the memory controller is configured to receive a plurality of logical addresses and data corresponding to the plurality of logical addresses; wherein the logical addresses include at least one of the first logical addresses or the third logical addresses. In some implementations, the processor is further configured to determine whether the plurality of received logical addresses are continuous and whether the data corresponding to the plurality of logical addresses is of the same data type, and generate a result for the determination.

In some implementations, when the result for the determination indicates that the plurality of logical addresses are continuous and the data corresponding to the plurality of logical addresses is of a same data type, generate the first identification code based on the result for the determination.

In some implementations, the processor is further configured to:
generate a plurality of third identification codes based on the result for the determination when the result for the determination indicates that the plurality of logical addresses are discontinuous.

In some implementations, the processor is further configured to: store the first identification code and the N pieces of first data in the buffer to a memory device based on a sum of capacity for the first identification code and the N pieces of first data reaching a preset capacity; or, store the first identification code and the N pieces of first data in the buffer to the memory device based on at least one of a power-off command from the host or detection of abnormal power-off.

In some implementations, the processor generates one identification code, one starting logical address and one length for logical addresses based on several data which may correspond to continuous logical addresses and be of the same data type, thus the storage space occupied by the identification code and logical address is greatly reduced, and this operation may be implemented by the processor executing executable instructions. It may be understood that through detecting the source code, it may be found that the data structure of the identification code and logical address optimized by the present disclosure has been changed.

TABLE 1
Comparison of sequential writing of scaled and unscaled
identification code and logical address

| | amount of data | Storage space occupied |
|---|---|---|
| | written | by identification |
| | sequentially | code and logical address |
| Unscaled | 1024 pieces | 8K |
| scaled | 1024 pieces | 8 bytes |

In some implementations, the memory system may be an enterprise-level solid state drive, since the processor may scale the identification code and logical address of the sequential data, a small storage space in the buffer and memory device is occupied by the identification code and logical address, thus the full sequential write capability of enterprise-level solid state drive is improved. For example, referring to Table 1, for writing 1024 pieces of sequential data of the same data type, if the processor does not scale the identification code and logical address, the storage space occupied by the identification code and logical address is 8K (the identification code and logical address corresponding to each piece of data occupy 8 bytes); if the processor scales the identification code and logical address, i.e., for 1024 pieces of sequential data of the same data type, only one identification code, one starting logical address and one length for logical addresses are generated, at this point, the storage space occupied by the identification code and logical address is 8 bytes, which is only 1/1024 of the unscaled case described above.

It should be understood that reference throughout the description to “one example” or “an example” means that a particular feature, structure or characteristic related to the example is included in at least one example of the present disclosure. Thus, appearances of “in one example” or “in an example” in various places throughout the description are not necessarily referring to a same example. Furthermore, these particular features, structures or characteristics may be combined in any appropriate manner in one or more implementations. It should be understood that in various implementations of the present disclosure, sequence numbers of the processes described above do not mean the execution order, and the execution order of each process should be determined by its function and internal logic, and should not constitute any limitation to example process of implementations of the present disclosure. The serial numbers of implementations of the present disclosure described above are for the purpose of description only, and do not represent the advantages and disadvantages of the implementations.

The above is only a preferred example of the present disclosure, and does not limit the patent scope of the present disclosure, and under the inventive concept of the present disclosure, any equivalent structural transformation made by using content of the present disclosure and the accompanying drawings, or direct/indirect application in other related technical fields are included in the patent protection scope of the present disclosure.

What is claimed is:

1. A memory controller, comprising:
a processor configured to:
determine a first logical address list indicating continuous N first logical addresses, where N is an integer greater than 1; N pieces of first data corresponding to the N first logical addresses comprise the same first data type; and
generate a first identification code indicating the first data type of the N pieces of the first data based on the first logical address list; and
a buffer coupled with the processor and configured to:
cache the first logical address list and the first identification code.

2. The memory controller of claim 1, wherein the first logical address list comprises:
a starting logical address comprising a 1st logical address or a Nth logical address of the continuous N first logical addresses; and
a length of the continuous N first logical addresses.

3. The memory controller of claim 1, wherein,
the processor is further configured to:
determine a second logical address list indicating continuous M second logical addresses, where M is an integer greater than 1; M pieces of second data corresponding to the M second logical addresses comprise the same second data type different from the first data type; and
generate a second identification code indicating the second data type of the M pieces of the second data based on the second logical address list; and
the buffer is further configured to:
cache the second logical address list and the second identification code.

4. The memory controller of claim 1, wherein,
the processor is further configured to:
generate P third identification codes respectively based on discontinuous P third logical addresses, wherein the P third identification codes respectively indicate the data type of P pieces of third data corresponding to the P third logical address; and
the buffer is further configured to:
cache the P third logical addresses and the P third identification codes respectively based on discontinuous P third logical addresses.

5. The memory controller of claim 4, wherein the processor is further configured to generate one identification code based on continuous logical addresses and the same data type corresponding to the continuous logic addresses.

6. The memory controller of claim 1, wherein the processor is further configured to generate a plurality of identification codes respectively base on discontinuous logical addresses.

7. The memory controller of claim 1, wherein the processor is further configured to:
store the first identification code and the N pieces of first data in the buffer to a memory device based on a sum of capacity for the first identification code and the N pieces of first data reaching a preset capacity; or
store the first identification code and the N pieces of first data in the buffer to the memory device based on at least one of a power-off command from a host or detection of abnormal power-off.

8. A method of operating a memory controller comprising a buffer and a processor coupled to the buffer, the method comprises:
caching a first logical address list indicating continuous N first logical addresses in the buffer, where N is an integer greater than 1; N pieces of first data corresponding to the N first logical addresses comprise the same first data type;
generating, by the processor, a first identification code indicating the first data type of the N pieces of first data based on the first logical address list; and
caching, the first identification code in the buffer.

9. The method of claim 8, wherein the first logical address list comprises a starting logical address and a length; the method further comprises:
determining, by the processor, the starting logical address and the length based on the continuous N first logical addresses.

10. The method of claim 8, further comprising:
caching a second logical address list indicating continuous M second logical addresses in the buffer, where M is an integer greater than 1; M pieces of second data corresponding to the M second logical addresses comprise the same second data type different from the first data type of the first data; and
generating, by the processor, a second identification code indicating the second data type of the M pieces of second data based on the second logical address list.

11. The method of claim 8, further comprising:
caching, discontinuous P third logical addresses in the buffer;
generating, by the processor, P third identification codes respectively indicate the data type of P pieces of third data corresponding to the P third logical address; and
caching the third identification codes in the buffer.

12. The method of claim 11, further comprising:
generating, by the processor, one identification code based on continuous logical addresses and the same data type corresponding to the continuous logic addresses.

13. The method of claim 12, further comprising:
generating, by the processor, a plurality of identification codes respectively based on discontinuous logical addresses.

14. The method of claim 8, further comprising:
storing, by the processor, the first identification code and the N pieces of first data in the buffer to a memory device based on a sum of capacity for the first identification code and the N pieces of first data reaching a preset capacity; or
storing, by the processor, the first identification code and the N pieces of first data in the buffer to the memory device based on at least one of a power-off command from a host or detection of abnormal power-off.

15. A memory system, comprising:
a memory device; and
a memory controller coupled with the memory device and comprises:
a processor configured to:
determine a first logical address list indicating continuous N first logical addresses, where N is an integer greater than 1; N pieces of first data corresponding to the N first logical addresses comprise the same first data type; and
generate a first identification code indicating the first data type of the N pieces of the first data based on the first logical address list; and
a buffer coupled with the processor and configured to:
cache the first logical address list and the first identification code.

16. The memory system of claim 15, wherein the first logical address list comprises:
a starting logical address comprising a 1st logical address or a Nth logical address of the continuous N first logical addresses; and
a length of the continuous N first logical addresses.

17. The memory system of claim 15, wherein
the processor is further configured to:
generate P third identification codes respectively based on discontinuous P third logical addresses, wherein the P third identification codes respectively indicate the data type of P pieces of third data corresponding to the P third logical address; and
the buffer is further configured to:
cache the P third logical addresses and the P third identification codes respectively based on discontinuous P third logical addresses.

18. The memory system of claim 17, wherein the processor is further configured to generate one identification code based on continuous logical addresses and the same data type corresponding to the continuous logic addresses.

19. The memory system of claim 18, wherein the processor is further configured to generate a plurality of identification codes respectively base on discontinuous logical addresses.

20. The memory system of claim 15, wherein the processor is further configured to:
store the first identification code and the N pieces of first data in the buffer to a memory device based on a sum of capacity for the first identification code and the N pieces of first data reaching a preset capacity; or
store the first identification code and the N pieces of first data in the buffer to the memory device based on at least one of a power-off command from a host or detection of abnormal power-off.
